(19) United States
(12) Patent Application Publication
(10) Pub. No.: US 2010/0207018 A1
(43) Pub. Date: Aug. 19, 2010

(54) METHOD AND APPARATUS FOR THE CHARACTERISATION OF GEOLOGICAL MATERIALS

(75) Inventors: Nenad Djordjevic, Brookfield (AU); Benjamin Joseph Adair, Karalee (AU)

Correspondence Address: EDWARDS ANGELL PALMER & DODGE LLP, P.O. BOX 55874, BOSTON, MA, 02205, US

(73) Assignee: THE UNIVERSITY OF QUEENSLAND, Brisbane (AU)

(21) Appl. No.: 12/376,887

(22) PCT Filed: Aug. 3, 2007
(86) PCT No.: PCT/AU07/01087

§ 371 Date: Apr. 14, 2010

(30) Foreign Application Priority Data
Aug. 9, 2006 (AU) AU 2006904299

(51) Int. Cl. G01V 5/04; G01V 8/02

(52) U.S. Cl. 250/256; 250/253

(57) ABSTRACT

The invention provides a method and apparatus for the identification of a constituent of or within a rock. The method included: applying low level electromagnetic energy to the rock thereby inducing a thermal response from the constituent; imaging the thermal response from the constituent to obtain thermal image within a plurality of distinctive bands of IR spectra; interpreting the thermal images to identify the constituent. The apparatus includes: a low level electromagnetic energy generator/applicator for inducing a thermal response from the constituent; an infra-red imaging device for imaging the thermal responses induced within a plurality of distinctive bands of IR spectra; and a computing device for interpreting the thermal images produced by the imaging device to identify the constituent within the rock.

### FIELD OF THE INVENTION

The present invention relates to a method and apparatus for characterization of geological materials. In particular, the invention relates to the identification of a constituent, such as a mineral or minerals, within a rock. More particularly, the invention relates to a methods and apparatus for identification of a mineral or minerals within a rock that employ the application of low level electromagnetic energy to the rock followed by imaging of the thermal response of the mineral(s) within the rock to the microwave energy.

The invention has particular, but non-exclusive application to the identification of minerals in drill-hole cores and geological samples, and also extends to identification of minerals on interior wall surfaces of boreholes and/or exposed rock surfaces in-situ.

### BACKGROUND TO THE INVENTION

Remote or non-contact sensing for the identification of minerals within rock formations is of significant importance in the art of geological exploration for mineral deposits. Remote sensing is based on the study of the interaction of geological material, particularly mineral deposits, with electromagnetic radiation. The radiation wavelengths traditionally considered cover visible and infra-red parts of the spectrum, generally within the range of from 0.35 to 40 μm. For solid materials, electromagnetic radiation is absorbed or emitted as a result of changes in the total energy content of the material. These transitions within the material take place between specific energy levels, and may be between different electronic energy levels or between different vibration levels.

In the former case transition appears in the visible or near infra-red (0.7-2.5 μm) part of the spectrum, while in the later case transition evidence appears in the infra-red part of the spectrum (1.2-40 μm). Vibration processes are determined by the chemical composition, the geometry and the positions of the constitutive atoms and the nature of inter-atomic forces. Therefore, information available in the infra-red part of the spectrum is directly related to the bulk properties of rocks and minerals. Due to the nature of rocks, for example ores, which are an ensemble of various minerals, the infra-red (IR) spectral response of a particular rock is a composite of the spectral responses of the constitutive minerals.

Various approaches have been previously employed for passive remote sensing of ground rock formations. Well-established techniques in multi-spectral and hyper-spectral analysis may be coupled with new, state-of-the-art imagery from space-borne, airborne and more recently ground based sensor systems, enabling their direct and immediate application to geological mapping.

Reflectance spectroscopy provides diagnostic information on the mineralogy of the uppermost few microns of a rock surface. This technique involves measuring the spectrum of sunlight reflected from the rock surface, and is therefore restricted to the wavelength range where the sun's flux is highest and where the amount of energy reflected from the rock surface is greater than the amount that is thermally emitted (the typical wavelength range is from 0.3 to 3.5 μm). Reflectance spectra reveal absorption features that are characteristic of certain minerals. For example, the mineral pyroxene, a common component of basaltic rocks on the Earth, can be detected remotely by the measurement of diagnostic absorption features near 1.0 and 2.0 μm. Variations in the abundances of Fe and Ca in the pyroxene can also be inferred based on subtle shifts in the positions of these bands.

High-quality imaging at near-IR and mid-IR wavelengths has recently become practical because of advances in infra-red-sensitive arrays. Specifically, arrays constructed from indium and antimony (InSb) substrates have had spectacular success in achieving high Signal to Noise Ratio (SNR) and high dynamic range for telescopic and spacecraft imaging applications. Other IR sensitive substrates, including silicon-arsenic (SiAs), germanium (Ge), and indium-gallium-arsenic (InGaAs), have also been used with good results. A particular advantage of many of these arrays is their ability to operate effectively with only modest cooling requirements.

Thermal infra-red (TIR) also provides diagnostic information on the mineralogy of rock surfaces, as well as additional information on surface thermo physical properties like temperature. Most of the major rock-forming minerals exhibit their fundamental molecular vibration spectral features at mid-infra-red wavelengths; typically from 3 to 25 μm. In remote sensing practice water and other gases in the atmosphere restricts aerial systems to two wavelength windows; 3 to 5 μm and 8 to 15 μm. Unlike reflectance spectra, thermal IR spectra can exhibit features in both emission and absorption, depending on the nature of the environment.

Because each rock is generally a combination of several minerals, spectral features in the composite spectrum are not normally well-defined. Generally, the spectrum appears smeared and in some cases the contributions from minor constituents may dominate the spectrum and completely mask the presence of the mineral which is in fact the target for mineral exploration.

The present invention, at least in certain embodiments, proposes a method and apparatus that employ active remote sensing and that make use of IR sensors that detect responses from objects that have been irradiated from an artificially-generated energy source. The proposed method and apparatus may advantageously have mineral detection capabilities that are superior to the presently used methodology and instruments.

### SUMMARY OF THE INVENTION

According to one aspect of the invention there is provided a method for the identification of a constituent of or within a rock including:
applying low level electromagnetic energy to the rock thereby inducing a thermal response from the constituent;
imaging the thermal response from the constituent to obtain thermal images within a plurality of distinctive bands of IR spectra; and
interpreting the thermal images to identify the constituent.

As used herein, the term “constituent” is intended to mean any element or component making up or forming part of a rock, a rock body, a core sample, geological or rock formation and so on. The term also extends to deposits, such as organic deposits, oil and gas, oil shale, oil sand, located within rocks, rock formations and so on.

The applied low level electromagnetic energy is preferably applied microwave energy or applied radiowave energy.

The low level electromagnetic energy may be applied as desired at a continuous power density, or as pulsed low level electromagnetic energy. It has been found that resolution of the resultant images is improved if the low level electromagnetic energy is applied as pulsed low level electromagnetic energy. As such, it is preferred that the low level electromagnetic energy applied is pulsed microwave energy or pulsed radiowave energy.

In the instance when the applied low level electromagnetic energy is microwave energy, the power density of the microwave energy applied to the rock is not particularly limited. Preferably, the microwave energy is applied at a power density of less than 1000 MW/m³, more preferably from 10 to 100 MW/m³.

Similarly, the frequency of the applied microwave energy is not particularly limited. Preferably, however, the microwave energy is applied at a microwave frequency of from 895 MHz to 245 GHz, more preferably from 895 to 3500 MHz, and even more preferably from 895 to 950 MHz. Suitably, the microwave energy is applied at a microwave frequency of from 895 to 915 MHz.

When the applied low level electromagnetic energy is radiowave energy, the frequency of the applied radiowave energy, whilst not particularly limited, is preferably at a radiowave frequency from 13.6 MHz to 895 MHz. More preferably the applied radiowave energy is a radiowave frequency from 400 MHz to 895 MHz.

More suitably the applied low level electromagnetic energy may be an applied radiowave energy having a radiowave frequency of 433.92 MHz or an applied microwave energy having a microwave frequency selected from 895 MHz, 915 MHz, 2450 MHz, 5800 MHz or 24.125 GHz.

Imaging of the constituent is conducted to image the thermal response of the constituent to the applied low level electromagnetic energy. This will provide a signature response for immediate or later consideration and analysis. Preferably imaging of the thermal response of the constituent includes infra-red imaging in the spectral range of from 0.7 to 2.5 μm, 3 to 5 μm and/or 8 to 15 μm. It has been found that the combined use of short wave IR (SWIR) and thermal infra-red (TIR) spectral ranges allows for the identification of a wide range of minerals. These spectral ranges are characterised with maximum variability in terms of IR responses (emissivity) between minerals and minimal absorption of IR energy in the atmosphere.

As will be dealt with in more detail below, the present invention facilitates an improved ability to distinguish various constituents within a rock as compared with prior art methods. That is, the images that may be obtained following the application of low level electromagnetic energy to the rock are substantially more distinct than those obtained without the application of microwave energy. IR images will be obtained over a plurality of distinctive bands of IR spectra. This facilitates more specific identification of the constituents within the rock, generally through comparison with a pre-established library of IR spectra or spectral data located on a computer database. It should be noted that the described imaging over a plurality of distinctive bands may include continuous imaging over an entire range covering these bands. For example, imaging over the range 3 to 5 μm will include a number of distinctive infra-red bands. That is, reference to imaging of distinctive bands should not be taken to mean exclusive imaging of those bands, but rather inclusive imaging of those bands.

Interpretation of the thermal images to identify the constituent or constituents will generally be achieved by comparing the thermal images, or parameters calculated from the thermal images, with a library of IR spectra or spectral data. In a particular embodiment of the invention, given that the thermal response of the constituent is imaged simultaneously within a plurality of (i.e. at least two) distinctive bands, a ratio of the two (or more) images may be calculated to define a complete signature for the particular constituent.

In that regard, without wanting to be bound by theory, IR images of the constituents will be affected by their temperature and their relative emissivity in comparison to black body emissivity at a given temperature. For thick, solid objects:

emmisivity=1−reflectivity.

Reflectivity, and consequently emissivity, of a constituent varies as a function of the IR wavelength. This is illustrated in the figures, as discussed below. In order to improve detection of constituents with a similar ability to absorb low level electromagnetic energy, in particular microwaves and radiowaves, one must use additional means to differentiate between those minerals. One such means is to compare thermal energy coming from the particular constituents in different parts of the IR spectra.

For instance, if one can measure the thermal energy coming from the constituent in the spectral range 4-5 micrometers and in the range 8-9 micrometers, from the known spectra of minerals we can determine what the ratio of these two IR bands will be for a given constituent at the same temperature. Using IR images simultaneously recorded in several ranges of IR spectra it is possible to calculate, for instance, the ratio of the two images to determine intensity of thermal radiation coming from each pixel of the image. This will facilitate constituent identification, even in the case where temperature of the constituents is practically the same. In the case where the low level electromagnetic absorbing capacity of the constituents varies, identification will be much easier due to the significantly higher temperature of the constituent having the higher absorbing capacity.

Therefore, in a particularly preferred embodiment of the invention a ratio of thermal images obtained is calculated and compared with a library of IR spectra.

In certain embodiments it may desirable to obtain a “blank” or reference image of the rock prior to application of the low level electromagnetic energy. As such, in some embodiments the method may include a preliminary step of imaging the rock to obtain a reference image prior to application of the low level electromagnetic energy.

One particular application of the method of the invention will be in the identification of constituents making up a length of an interior wall of a borehole in situ. Such a method would provide advantages as would be readily appreciated by those of skill in the art.

Therefore, according to a particular aspect of the present invention there is provided a method of mapping the composition of a borehole including:
applying low level electromagnetic energy to a length of interior wall of the borehole thereby inducing thermal responses from constituents making up the length of interior wall;
imaging the thermal responses from the constituents to obtain a series of thermal images within a plurality of distinctive bands of IR spectra;
interpreting the series of thermal images to identify the constituents; and
thereby mapping the composition of the borehole.

In another particular application of the method of the invention, the remote mapping of the composition of a rock formation is provided.

Therefore, according to a further aspect of the invention there is provided a method of remotely mapping the composition of a rock formation including:
remotely applying low level electromagnetic energy to an exposed surface of the rock formation thereby inducing thermal responses from constituents making up the exposed surface;
remotely imaging the thermal responses from the constituents to obtain a series of thermal images within a plurality of distinctive bands of IR spectra;
interpreting the series of thermal images to identify the constituents; and
thereby mapping the composition of the rock formation.

The present invention also extends to various forms of apparatus that have been developed for carrying out the methods as described above.

In particular, according to yet another aspect of the invention there is provided an apparatus for identification of a constituent within a rock including:
a low level electromagnetic generator/applicator for inducing a thermal response from the constituent;
an infra-red imaging device for imaging the thermal responses induced within a plurality of distinctive bands of IR spectra; and
a recording device for recording images produced by the infra-red imaging device; and/or
a computing device for interpreting thermal images produced by the infra-red imaging device to identify the constituent within the rock.

The low level electromagnetic generator/applicator may be a microwave generator/applicator. The microwave generator/applicator may take any suitable form. For example, this may be a microwave horn, or other microwave generating device. Preferably, the microwave generator generates microwave energy at a power density of less than 1000 MW/m³, more preferably from 10 to 100 MW/m³.

Likewise, the microwave generator preferably generates microwaves at a microwave frequency of from 895 MHz to 245 GHz, preferably from 895 to 3500 MHz, more preferably from 895 to 950 MHz. Suitably the microwave energy is applied at a microwave frequency of from 895 to 915 MHz.

More suitably the microwave generator generates microwaves at a microwave frequency selected from 895 MHz, 915 MHz, 2450 MHz, 5800 MHz or 24.125 GHz.

The low level electromagnetic generator/applicator alternatively may be a radiowave generator/applicator. The radiowave generator/applicator may take any suitable form.

Likewise, the radiowave generator preferably generates radiowaves at a radiowave frequency of from 13.6 to 895 MHz, preferably from 400 to 895 MHz, more preferably a frequency of 433.92 MHz.

The imaging device may also take any suitable form, for example this may be any type of spectroscopic device. Preferably, however, the imaging device is a high resolution infra-red camera with a number of band pass IR filters.

Taking the particular application of the invention to the identification of constituents within a borehole, in one aspect the invention provides an apparatus for mapping the composition of a borehole, the apparatus including:
a mapping sonde adapted to be lowered into the borehole;
a low level electromagnetic generator/applicator associated with the mapping sonde for inducing thermal responses from constituents making up a length of interior wall of the borehole;
an infra-red imaging device associated with the mapping sonde for imaging the thermal responses induced within a plurality of distinctive bands of IR spectra; and
a recording device for recording images produced by the infra-red imaging device; and/or
a computing device for interpreting thermal images produced by the imaging device to identify the constituents making up the interior wall of the borehole.

Each of the apparatus described above are provided with a recording device and/or a computing device. It will be appreciated that in some instances images may be recorded for later analysis at another location, in which case a computing device for conducting the analysis on site will not be essential. Likewise, it may be that the analysis is conducted on site in real time, in which case it may not be necessary to record the images. Rather the results of the analysis using the computing device (i.e. the compositional mapping of the rock, etc.) may be recorded.

### DETAILED DESCRIPTION OF PREFERRED EMBODIMENTS

A more detailed description of the invention will now be provided. It should however be understood that the following description is provided for exemplification only and should not be construed as limiting on the invention in any way. In the following description reference will be made to the drawings, in which:

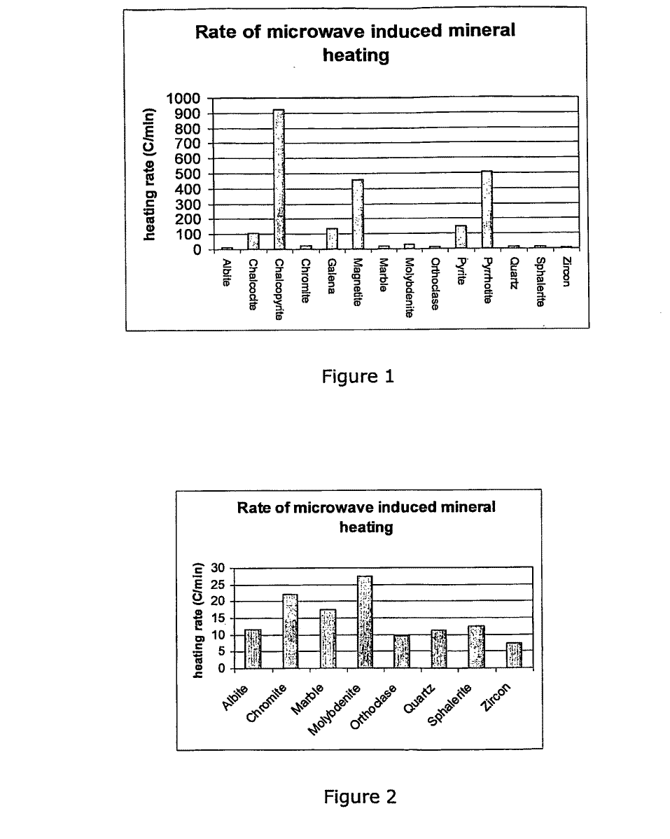

FIG. 1 illustrates a graph of rate of microwave induced heating of a number of minerals;

FIG. 2 illustrates a graph of rate of microwave induced heating of some minerals having low microwave absorption;

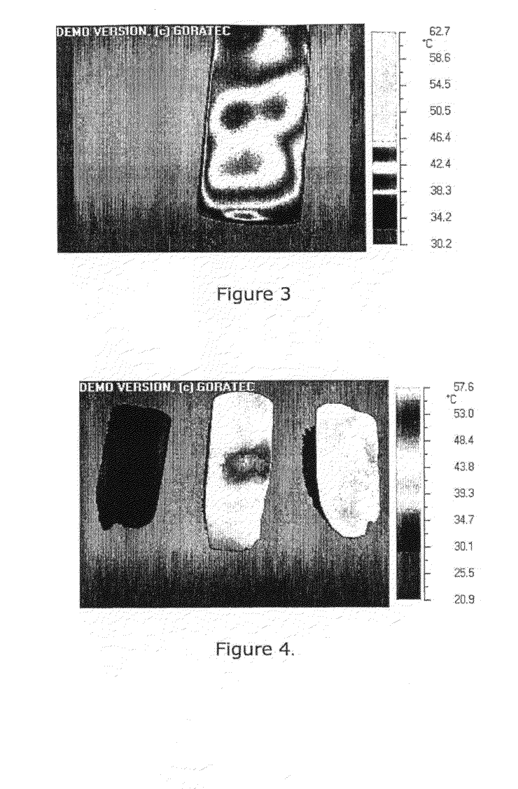

FIG. 3 illustrates an IR image of a microwave illuminated ore fragment;

FIG. 4 illustrates a TIR image of a number of drill core samples;

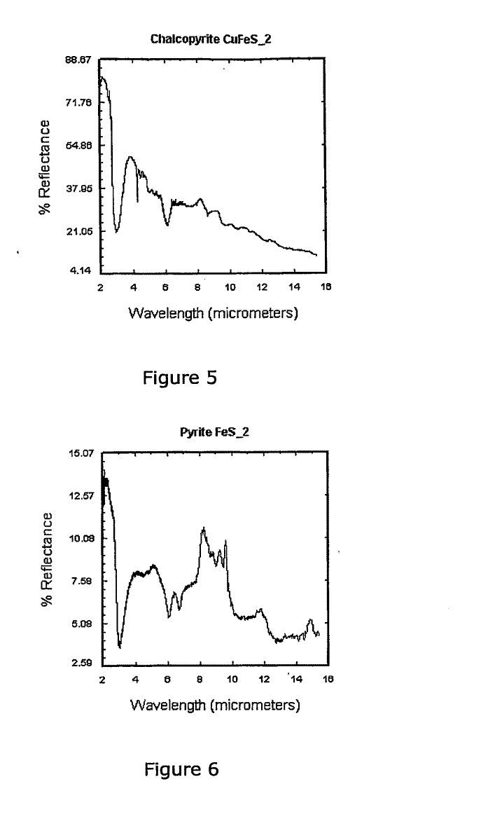

FIG. 5 illustrates IR spectra for a chalcopyrite sample;

FIG. 6 illustrates IR spectra for a pyrite sample;

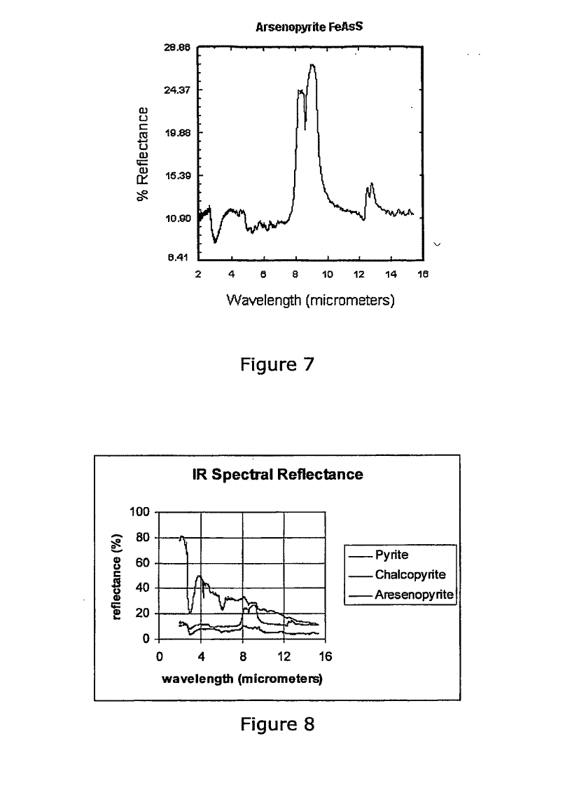

FIG. 7 illustrates IR spectra for an arsenopyrite sample;

FIG. 8 illustrates the combined IR spectra from FIGS. 5-7; and

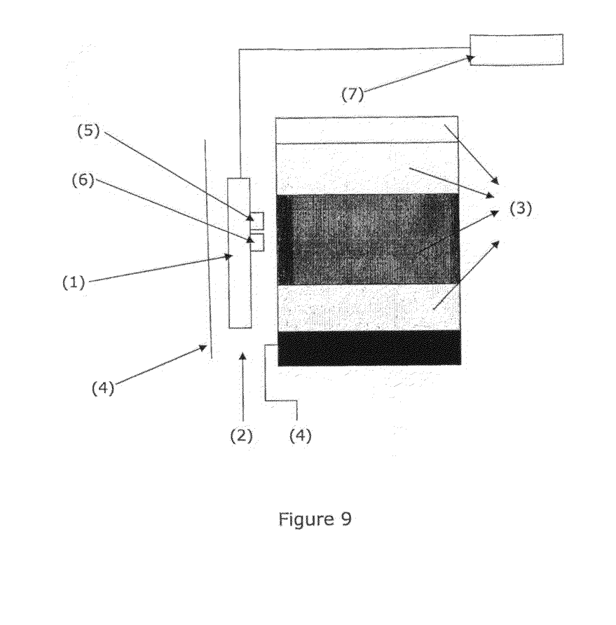

FIG. 9 illustrates an embodiment of an assembly of the invention.

The present invention relates to a method and apparatus for active remote sensing, generally based on the short pulse illumination of drill-hole cores, geological samples, rock surfaces within a borehole or exposed rock surfaces in-situ, using a suitable microwave source and applicator. The proposed method and apparatus do not deal with IR/microwave applications related to the sorting of high and low grade metal ore or waste rock fragments for the purpose of grade increase of ore that will be subject to further mineral processing. Nor does the invention relate to upgrading oil recovery from oil containing geological materials.

The invention does, however, have fields of application in mineral/rock type detection, exploration and mapping and classification of other than metal bearing ore concentrations within mines and associated mineral processing plants. As such, hereafter particular reference will be made to the identification of minerals within a rock, rock body, core drill, geological or rock formation and so on. Such references are not to be construed as limiting on the invention.

The below detailed description of the invention describes the invention when the low level electromagnetic energy is microwave energy. It will be appreciated that similar methodologies and apparatus also apply when the applied low level electromagnetic energy is radiowave energy.

During and immediately following the short pulse microwave illumination of the rock, drill core, rock fragment or rock mass in situ, IR imaging of the exposed rock surface takes place. IR imaging is performed using a high-resolution IR camera that operates over the spectral range of IR emissivity of the targeted minerals or group of minerals. The most common spectral ranges will be from 0.7-2.5 μm, 3-5 μm and 8-15 μm. As noted above, the combined use of short wave IR (SWIR) and thermal infra-red (TIR) spectral ranges allows for identification of a wide range of minerals.

The rock surface, drill core, or borehole wall is subjected to short pulsed microwave irradiation of low to moderate power density to induce differential heating which correlates with the presence of microwave absorbing minerals within the rock surface, drill core etc. The thermal responses of minerals to microwave illumination vary to a large extent. Experimental results show that the highest microwave heating rate occurs for carbon (coal) and most metal oxides. Most metal sulfides heat rapidly as well.

Gangue minerals such as quartz, calcite and feldspar heat relatively slowly when exposed to microwave radiation. The proposed technique, however, may also provide the opportunity to differentiate between ranges of ferromagnesian and felsic silicates. For example, due to the presence of different amounts of metals, such as Fe, Cu, Pb etc, within particular silicate minerals, the method of the invention will be able to distinguish between varieties of silicates.

Reference is made to FIGS. 1 and 2 that illustrate a plot of rate of microwave induced heating of various minerals.

According to the Stefan-Boltzmann law, emissive infra-red power of a material can be calculated as:

E=εσT⁴

Where E (W/m²) is emissive power, ε is the emissivity constant of the material at the particular wavelength and temperature, σ is constant and T is absolute temperature of the material. Based on this equation, any increase in the temperature of the material will significantly increase the amount of infra-red radiation that the material will radiate. Hence, even small variations in the ability of minerals to absorb microwave energy and convert that energy into heat will result in significant variation of total infra-red power emitted from a particular mineral or group of minerals.

The thermal images that are obtained contain regions of different brightness (or equivalent false colours). Intensity of electromagnetic flux coming from the surface of the rock will be directly proportional to the temperature of the rock surface, multiplied by the emissivity of the particular rock or minerals within the rock. Based on that it is possible to use microwave induced selective heating as a parameter for the identification of minerals within the rock. For example, rocks containing a large proportion of quartz (such as granite) are characterised by relatively low TIR emissivity (˜0.75-0.8), while rocks with a low content of SiO₂ (such as basalt and gabbro) are characterised with high average TIR emissivity (>0.9).

The infra-red emissivity spectrum of each mineral has a signature characterised by the position of a number of maximums and minimums in the spectrum (reference is made to FIGS. 5 to 8). With an increase in the temperature of particular minerals, these spectral features (i.e. the position in the spectrum) will be preserved, but their intensity will be multiplied by a factor determined by the difference in temperature that exists between the specific mineral phase and the IR sensor. Infra-red images are recorded over several distinctive spectral bands within the thermal infra-red part of the spectrum.

The recorded information is compared with reference IR spectral data of various minerals. It is noted that the IR spectra of a wide range of minerals are readily available from public domain sources.

Following from the above, the IR images of the illuminated rocks or minerals of different type will show a substantially improved differential compared with non-illuminated rocks. In the case of non-microwave illuminated rocks, the difference in IR emissivity between minerals varies in the range of 15-20%, while in the case of microwave illuminated rocks the difference in IR emissivity between minerals is in the order of 50-100% or more. Therefore, the invention provides for improved delineation between various mineral types.

A difference in the surface temperatures of a rock surface will be evident due to different rates of absorption of microwave energy of the different minerals making up the rock surface. Hence, in such a way the method of the invention facilitates differentiation between minerals which, from the point of view of classical IR sensing, are almost identical. Selective microwave energy absorption further differentiates minerals, enhancing detection capabilities of the system. Using this approach it is advantageously possible to differentiate among silicate minerals because of differences that exist in their ability to absorb microwave energy. Reference is made to FIG. 2.

Reference is also made to FIGS. 3 and 4 that provide thermal images of microwave illuminated samples of various mineral types.

A schematic illustration of an embodiment of the invention is provided in FIG. 9. FIG. 9 illustrates a mapping or geophysical sonde (1) which may be used to map rock types and map mineral composition of rock intersected with a borehole (2). For illustration purposes only the rock types and mineral composition (3) at or near the borehole wall (4) are shown as being stratified. It will be appreciated that rock types and mineral compositions (3) will vary significantly from location to location. In this embodiment, the borehole must not be filled with water prior to analysis.

First, a reference IR image is taken over a plurality of bands of IR spectra before microwave energy is applied to the borehole wall (4). The low level electromagnetic energy, in this example is microwave energy is then applied, by a microwave generator/applicator (5) to the borehole wall (4) and immediately after each microwave energy application an IR image is collected using a suitable IR sensor or IR imaging device (6). The infra-red (IR) imaging device (6) is preferably an IR imaging camera equipped with a number of suitable band pass filters

Images are collected within a plurality of distinctive spectral bands, covering the thermal infra-red part of the spectrum. Recorded images are sent via cable into a central recording device (7) for processing and, if desired, interpretation.

In certain embodiments the apparatus may take the form of a surface device, handheld or mounted on vehicle, that will apply microwave energy onto the surface of a rock formation in-situ, ore body outcrop, or rock wall in an active mine. The apparatus may simultaneously, and immediately after application of the microwave energy, collect IR images using a suitable IR sensor. In such a way the apparatus and method may be used for geological exploration and delineation and the detection of mineralised zones either within or around existing mines or at greenfield sites.

The apparatus of the invention, and consequently the method of the invention, may also be embodied in the form of device for mapping and identification of minerals in drill hole cores after they are removed to the surface. In such a case, the drill core may be conveyed through, or against the microwave generator. During passage through the microwave generator/applicator, short microwave pulses transfer microwave energy into the rock, thereby inducing a thermal response. The thermal responses are recorded using an IR imaging sensor over a number of bands of IR spectra. Based on the recorded IR responses within selected spectral bands, the minerals within the rock can be classified. Classification will be performed by comparing the recorded IR spectral responses with a library of IR spectra for various minerals.

The apparatus of the invention may also be embodied in the form of device for mineral identification within rock samples supplied to a laboratory. Rock can be exposed to microwave illumination using a small scale microwave applicator. Induced thermal response of the minerals within the rock can be recorded using an IR imaging device. The recorded images can then be analysed using a range of filters to extract characteristic spectral features of each mineral phase present in the rock. Due to differential heating, IR spectral features of particular minerals will be further enhanced. Consequently, the minerals within the rock can be identified with greater confidence as compared with current IR imaging techniques.

It will of course be realised that the above description is provided by way of illustrative example only of the invention and that all such modifications and variations thereto as would be apparent to persons skilled in the art are deemed to fall within the broad scope and ambit of the invention as herein set forth.

1. A method for the identification of a constituent of or within a rock including:
applying low level electromagnetic energy to the rock thereby inducing a thermal response from the constituent;
imaging the thermal response from the constituent to obtain thermal image within a plurality of distinctive bands of IR spectra;
interpreting the thermal images to identify the constituent.

2. A method according to claim 1, wherein the low level electromagnetic energy applied is microwave energy.

3. A method according to claim 2, wherein the microwave energy applied is pulsed microwave energy.

4. A method according to claim 3, wherein the microwave energy is applied at a power density of less than 1000 MW/m³.

5. A method according to claim 4, wherein the microwave energy is applied at a power density of from 10 to 100 MW/m³.

6. A method according to claim 3, wherein the microwave energy is applied at a microwave frequency of from 895 MHz to 245 GHz.

7. A method according to claim 6, wherein the microwave energy is applied at a microwave frequency of from 895 to 3500 MHz.

8. A method according to claim 6, wherein the microwave energy is applied at a microwave frequency of from 895 to 915 MHz.

9. A method according to claim 6, wherein the microwave energy is applied at a microwave frequency selected from 895, 915 MHz, 2450 MHz, 5800 MHz and 24.125 Ghz.

10. A method according to claim 1, wherein the low level electromagnetic energy applied is radiowave energy.

11. A method according to claim 10, wherein the radiowave energy is applied at a radiowave frequency of from 13.6 MHz to 895 MHz.

12. A method according to claim 11, wherein the radiowave energy is applied at a radiowave frequency of from 400 MHz to 895 MHz.

13. A method according to claim 11, wherein the radiowave energy is applied at a radiowave frequency of 433.92 MHz.

14. A method according to claim 1, wherein imaging includes infra-red imaging in the spectral range of from 0.7 to 2.5 μm, 3 to 5 μm and/or 8 to 15 μm.

15. A method according to claim 1, wherein a ratio of emissivity or reflectance obtained from the thermal images over the plurality of distinctive bands of IR spectra is calculated and compared with a library of IR spectra.

16. A method according to claim 1, including a preliminary step of imaging the rock to obtain a reference image prior to application of the low level electromagnetic energy.

17. A method of mapping the composition of a borehole including:
applying low level electromagnetic energy to a length of interior wall of the borehole thereby inducing thermal responses from constituents making up the length of interior wall;
imaging the thermal responses from the constituents to obtain a series of thermal images within a plurality of distinctive bands of IR spectra;
interpreting the series of thermal images to identify the constituents; and
thereby mapping the composition of the borehole.

18. A method of remotely mapping the composition of a rock formation including:
remotely applying low level electromagnetic energy to an exposed surface of the rock formation thereby inducing thermal responses from constituents making up the exposed surface;
remotely imaging the thermal responses from the constituents to obtain a series of thermal images within a plurality of distinctive bands of IR spectra;
interpreting the series of thermal images to identify the constituents; and
thereby mapping the composition of the rock formation.

19. An apparatus for identification of a constituent within a rock including:
a low level electromagnetic energy generator/applicator for inducing a thermal response from the constituent;
an infra-red imaging device for imaging the thermal responses induced within a plurality of distinctive bands of IR spectra; and
a computing device for interpreting the thermal images produced by the imaging device to identify the constituent within the rock.

20. An apparatus according to claim 19, wherein the low level electromagnetic energy generator/applicator is a microwave generator.

21. An apparatus according to claim 20, wherein the microwave generator generates microwave energy at a power density of less than 1000 MW/m³.

22. An apparatus according to claim 21, wherein the microwave generator generates microwave energy at a power density of from 10 to 100 MW/m³.

23. An apparatus according to claim 20, wherein the microwave generator generates microwaves at a microwave frequency of from 895 MHz to 245 GHz.

24. An apparatus according to claim 23, wherein the microwave generator generates microwaves at a microwave frequency of from 895 to 3500 MHz.

25. An apparatus according to claim 23, wherein the microwave generator generates microwaves at a microwave frequency of from 895 to 915 MHz.

26. An apparatus according to claim 23, wherein the microwave generator generates microwaves at a microwave frequency selected from 895 MHz, 915 MHz, 2450 MHz, 5800 MHz or 24.125 GHz.

27. An apparatus according to claim 19, wherein the low level electromagnetic energy generator/applicator is a radiowave generator.

28. An apparatus according to claim 27, wherein the radiowave generator generates radiowaves at a radiowave frequency of from 13.6 MHz to 895 MHz.

29. An apparatus according to claim 28, wherein the radiowave generator generates radiowaves at a radiowave frequency of 433.92 MHz.

30. An apparatus according to claim 19, wherein the imaging device is a high resolution infra-red camera equipped with a number of band pass IR filters.

31. An apparatus for mapping the composition of a borehole, the apparatus including:
a mapping sonde adapted to be lowered into the borehole;
a low level electromagnetic generator/applicator associated with the mapping sonde for inducing thermal responses from constituents making up a length of interior wall of the borehole;
an infra-red imaging device associated with the mapping sonde for imaging the thermal responses induced within a plurality of distinctive bands of IR spectra; and
a recording device for recording images produced by the infra-red imaging device; and/or
a computing device for interpreting thermal images produced by the infra-red imaging device to identify the constituents making up the interior wall of the borehole.

32. The apparatus of claim 26, wherein the low level electromagnetic generator/applicator is a microwave generator/applicator or a radiowave generator/applicator.
